(19) United States
(12) Patent Application Publication
(10) Pub. No.: US 2002/0068127 A1
(43) Pub. Date: Jun. 6, 2002

(54) Process for selectively plating areas of a substrate

(76) Inventors: Francis Durso, Cheshire, CT (US); Steven Castaldi, Torrington, CT (US); David Sawoska, Watertown, CT (US)

Correspondence Address: John L. Cordani, Carmody & Torrance LLP, P.O. Box 1110, 50 Leavenworth Street, Waterbury, CT, 06721-1110, US

(21) Appl. No.: 09/729,410

(22) Filed: Dec. 4, 2000

(51) Int. Cl. B05D 3/10

(52) U.S. Cl. 427/125; 427/256; 427/304

(57) ABSTRACT

A process for the selective activation and plating of a substrate is disclosed. The process involves the application of an activator composition to a substrate in a predetermined pattern by means of a print head wherein the print head moves across the surface of the substrate and selectively deposits the activator composition in said predetermined pattern upon the substrate. The selectively activated substrate is then subjected to electroless plating.

### BACKGROUND OF THE INVENTION

The present invention relates to a process for the selective activation and plating of surfaces. The process is particularly useful in the fabrication of printed circuit boards, allowing the capability of defining, activating and plating circuit features in a selective manner.

In general, selective plating (metallization) processes, whereby metal is provided on a substrate in a predetermined aesthetic and/or functional pattern, are well known and have particular application in the manufacture of printed circuit boards.

In the manufacture of printed circuit boards, it is now commonplace to produce printed circuitry on both sides of a planar rigid or flexible insulating substrate. Of increased importance is the manufacture of multi-layer printed circuits. In these products, the board consists of parallel, planar, alternating innerlayers of insulating substrate material and conductive metal. The exposed outer sides of the laminated structure are provided with circuit patterns as with double-sided boards, and the inner layers of a multi-layer board may themselves contain circuit patterns.

In double-sided and multi-layer printed circuit boards, it is necessary to provide conductive interconnection between or among the various layers or sides of the board containing conductive circuitry. This is commonly achieved by providing metallized, conductive thru-holes in the board communicating with the sides and layers requiring electrical interconnection. Typically, thru-holes are drilled or punched through the board structure at desired locations. The then exposed hole surfaces, consisting partly or entirely of insulating material, are then metallized, generally by utilization of electroless metal depositing techniques.

In terms of providing the desired circuit pattern on the board (and/or innerlayers), the art has developed a variety of manufacturing sequences, many of which fall into the broad categories of “substrative” or “additive” techniques, depending upon whether circuit features are defined by removing materials (usually copper) or adding materials (usually copper) respectively.

Additive processes begin with exposed substrate surfaces and build up thereon metallization in desired (select) areas. Generally this selective plating is accomplished through the use of plating masks which are either stenciled or photoimaged onto the substrate in the negative image of the desired circuitry, thus allowing plating to occur only on the areas of the substrate not covered by the plating mask (i.e. the positive image of the desired circuitry). Problems occur in these processes because the plating masks used have difficulty maintaining definition and adhesion to the substrate during the plating process. Thus if the plating mask fails to maintain definition and adhesion, the definition of the circuitry will also fail, generally causing shorts. The reliability of additive processing is therefore currently questionable. For a discussion of additive processing please refer to U.S. Pat. No. 4,897,118, the teachings of which are incorporated herein by reference in their entirety.

In one additive technique known in the art, the insulating substrate surfaces are first sensitized and activated to form a blanket catalyzed layer thereon. Next the appropriate resist pattern (i.e. a positive pattern) is formed over the catalyzed layer so as to leave exposed only the areas where metallization is desired. Thereafter, the substrate is treated in an electroless metal depositing solution to effect metallization only of the catalyzed and exposed desired areas. In that process, however, it is necessary after removal of the resist to dissolve the catalytic layer which was under the resist so as to prevent excessively low surface resistivity between metallized areas on the substrate due to the catalytic layer.

In another proposed technique, a negative pattern of resist is first applied to the substrate surfaces. The entire surface (including the resist surfaces) is then sensitized and activated. The resist is then stripped away leaving only the substrate activated surfaces to be plated via electroless plating solutions. The substrate is then contacted with a plating solution, typically an electroless plating solution, in order to metallize only the areas which have activator upon them.

In any case, typically in additive processes, the substrate to be plated must be activated in order to reduce and/or receive plating upon the desired areas. Generally these activator solutions include noble metal(s) in ionic or colloidal form. As noted the activator is either applied in blanket form across all of the surfaces and then a plating mask is applied to cover the surfaces not desired to be plated or a plating mask is applied first to define the areas of the substrate to be contacted with the activator and then the plating mask is stripped away prior to plating. In either case a separate plating mask is required to provide definition of the circuitry. Typical activators are described in U.S. Pat. Nos. 4,863,758; 3,011,920 and 3,672,938, the teachings of each of which are incorporated herein by reference in their entirety.

Typical activators in that regard can range from simple ionic solutions of the noble metal salt, such as a solution of palladium chloride to complex colloids of the noble metal, such as a tin-palladium sol. A typical tin-palladium sol activator may consist of a noble metal that is catalytic to a chemical reduction plating process (e.g. palladium chloride), salts capable of forming a protective metal sol in water (e.g. tin salts), and a source of halide ions in excess of that provided by the noble metal salt and salts for forming the protective metal sol. Other ingredients may include organic acids, inorganic acid and a variety of organic additives or colloid stabilizers.

It is thus an object of this invention to propose a process for selectively plating a substrate, preferably a non-conductive substrate, without the use of a separate plating mask.

### SUMMARY OF THE INVENTION

The invention herein proposes a process for selectively activating and plating certain areas of the surface of a substrate. The process involves selectively applying activator, and possibly any other chemicals necessary to prepare the surface for plating if desired, to the surface to be plated using a programmed print head to spray the activator (and other chemicals) onto the surface only in the areas desired to be plated. The activator is then preferably allowed to dry on the surfaces where it has been applied and the substrate is subsequently contacted with the plating solution such that plating occurs only in areas where activator has been applied.

### BRIEF DESCRIPTION OF THE DRAWINGS

FIG. 1 is a perspective view of portions of a printing mechanism useful in carrying out this invention.

FIG. 2 is a block diagram of a control system for the printing mechanism.

### DETAILED DESCRIPTION OF THE INVENTION

A process for selectively metalizing a substrate is disclosed which process comprises:

1. Selectively applying an activator composition capable of rendering the area of the substrate where the composition is applied catalytic to a subsequent plating bath;

2. Contacting the substrate with a plating bath; wherein plating occurs in the areas where said activator composition was selectively applied but substantially no plating occurs on portions of the substrate where no activating composition was applied.

Activator compositions useful in practicing this invention include ionic solutions of and colloidal dispersions of noble metals. Typical useful activator compositions are described in U.S. Pat. No. 4,863,758, which describes colloidal activator dispersions of palladium. The noble metal chosen for the activator must generally be a metal which is more noble than the metal to be plated from the subsequent plating bath. An activator composition may be any composition which when applied to a substrate, will induce plating upon the area of the substrate where the activator composition has been applied, when the substrate is placed in contact with a plating bath. Generally it is preferable for the activator to comprise a metal or metal ions which are more noble than the metal to be plated out of the plating bath and for the metal or metal ions of the activator solution to absorb onto the surface of the substrate to be plated.

The activator composition must be effective to render the area of the substrate, where the activator composition is applied, catalytic to the action of the subsequent plating bath. This means that when the subsequent plating bath contacts the area of the substrate previously treated with the activator composition the treated area will induce the plating bath to plate upon the treated area. However, substantially no plating will occur on portions of the substrate that have not been treated with the activator composition.

The activator is applied to the substrate using a programmable print head(s) having at lease one nozzle for ejecting the activator composition towards the substrate. With orthogonal x and y axes in the plane of the substrate, the print head moves across the substrate in both x and y directions applying the activator composition in a selective, pre-determined pattern upon the substrate. In the case of manufacturing a printed circuit board, the print head would move across the laminate (substrate) in both x and y directions (or the substrate may move in one direction while the print heat moves in the other, preferably orthogonal, direction) and apply the activator composition in the positive image of the circuit features to be formed by selectively spraying the activator composition onto portions of the substrate where metallized circuitry is desired but substantially applying no activator composition to other areas of the substrate. The print head may consist of any device capable of selectively applying the activator composition to the surface of the substrate, by allowing the activator composition to selectively flow from the print head to the substrate.

The print head should be equipped with a spray control means for rapidly initiating and terminating the ejection of activator composition towards the substrate. Thus as the print head moves across the substrate with the spray control means initiating and terminating the flow of activator composition such that the desired selective application of activator composition is achieved. One means of spray control is to employ a piezoelectric element, as discussed in U.S. Pat. No. 6,104,178, the teachings of which are incorporated herein by reference in their entirety. In a print head using piezoelectric spray control elements, a drive signal (voltage), which abruptly changes in accordance with a predetermined program, is applied to the piezoelectric element arranged on a nozzle opening thereby causing a volume change in the piezoelectric element which causes droplets of activator composition to flow from the nozzle openings. Thus the activator is selectively printed onto the substrate by ejecting droplets of activator composition from the nozzle openings via a spray control means such as a piezoelectric element.

The print head assembly must also be equipped with a registration means such that the location of the print head(s) in relation to the substrate is consistently determined and measured. The registration means is necessary to ensure the proper selective printing of the activator composition and the proper registration of the resultant image in relation to the substrate. One such registration means is described in U.S. Pat. No. 6,106,101.

U.S. Pat. No. 6,106,101, the teachings of which are incorporated herein by reference in their entirety, discusses the selective printing of multiple liquids (colors) onto a substrate. In this case, the substrate is conveyed by at least two print heads, while the print heads move substantially orthogonally to the conveying direction of the substrate. At the same time liquid is ejected from the nozzles of the print heads at predetermined times. The positions of the print heads are determined by an encoder device. The ink is again ejected from the print head nozzles using piezoelectric elements, as a spray control means, and a predetermined voltage signal to the piezoelectric elements such that the flow of liquid is initiated and stopped at the appropriate intervals. Thus using the arrangement discussed in U.S. Pat. No. 6,106,101, not only may the activator composition be selectively applied to the substrate in the positive image of the desired circuitry elements but other necessary chemicals such as conditioners, pre-dips and accelerators may be applied in the same or similar selective manner.

In either case the print head(s) may contain their own internal reservoirs of chemicals to be applied and/or they may be connected to remote reservoirs of chemicals. Remote reservoirs of chemicals will generally make the application of chemicals more efficient over time.

In some cases the print heads may be arranged such that they move only substantially orthogonally to the conveyance direction of the substrate. In this case the registration means may consist of a series of readable slits along the path of motion of the print heads. Thus the print head is equipped with an encoder device which reads the slits, as the print head moves, and generates an encoder signal that gives the position of the print heads to a central processing unit. The central processing unit then uses the encoder signal to control the position of the print head in relation to the position and feed of the substrate in accordance with the predetermined pattern. The substrate feed mechanism will also provide location information to the central processing unit regarding the position and feed rate of the substrate. In other cases the print head(s) may be designed to move in both the x and y directions over the substrate. In this case the registration means may be based upon laser light signals from the print head(s) to certain fixed reference points or through the same encoder device and readable slits disposed along two axes instead of one.

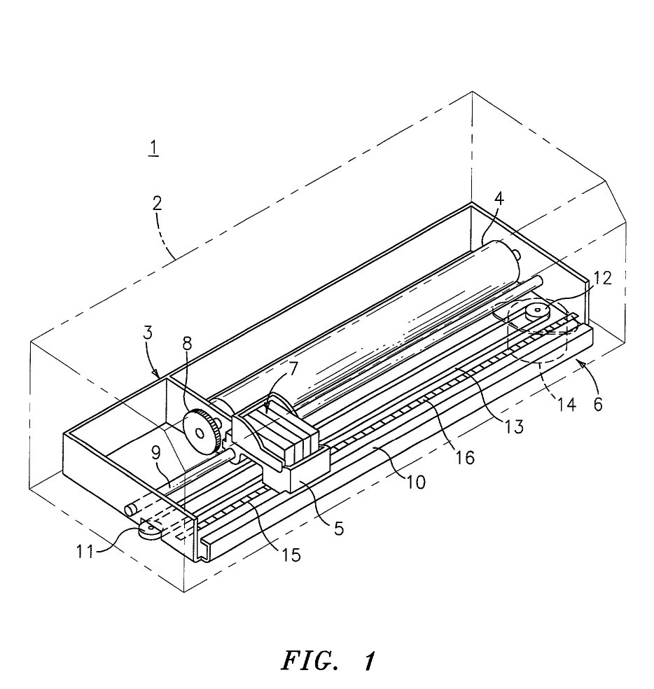

FIG. 1 represents a perspective view of a printing mechanism, 1, useful in selectively applying an activator composition in accordance with this invention, where, in this case, the substrate is conveyed under the print head, 5, while the print head moves substantially orthogonally to the direction of conveyance of the substrate. The printing mechanism, 1, has a body frame, 3, disposed in a body cover, 2, indicated by broken lines. Disposed in the body frame, 3, are a drive roller, 4, which conveys the substrate past print head, 5, and a print head drive mechanism, 6. The print head, 5, has an activating composition reservoir, 7, and a spray control mechanism not shown which is a piezoelectric element.

The drive roller, 4, is rotatably supported at both ends by body frame, 3. A drive roller gear, 8, is provided on the left side end of the drive roller, 4, and is driven by a substrate conveying motor not shown. The print head, 5, is moveably supported by a guide rod, 9, and by a guide rail, 10. The guide rod is supported at both ends by body frame, 3, and the guide rail forms a portion of the body frame, 3.

The print head, 5, is fixed at its lower portion to a predetermined site on a belt, 13, extending parallel to the guide rod, 9, and the guide rail, 10, and which belt, 13, is disposed on pulleys, 11 and 12, disposed at opposite side ends of the body frame, 3. A pulley, 12, is provided on a drive shaft of a carriage motor, 14. Driven by the carriage motor, 14, the print head, 5, is moved along guide rod, 9, and guide rail, 10, thereby scanned in direction substantially orthogonal to the conveyance direction of the substrate (not shown).

The print head, 5, carries thereon an activator composition reservoir, 7, as well as at least one nozzle, not shown, which is capable of ejecting the activator composition in the direction of the substrate and a spray control means, not shown, consisting of a piezoelectric element, which is capable of controlling (initiating and terminating) the ejection of the activator composition towards the substrate. By driving the piezoelectric element(s) the print head, 5, ejects activator composition from activator composition reservoir, 7, through the nozzle (not shown) in the direction of the substrate being conveyed below the print head, 5.

An encoder scale, 15, extends in the scanning directions of the print head, 5. The encoder scale, 15, has optically readable slits, 16, that are distributed in the direction of the length of the encoder scale, 15. The density of optically readable slits, 16, along the encoder scale will determine, in part, the registration precision of the printing mechanism in relation to the substrate. The print head, 5, is provided with an encoder device (not shown) that reads slits, 16, and generates an encoder signal corresponding to the position and moving speed of the print head, 5.

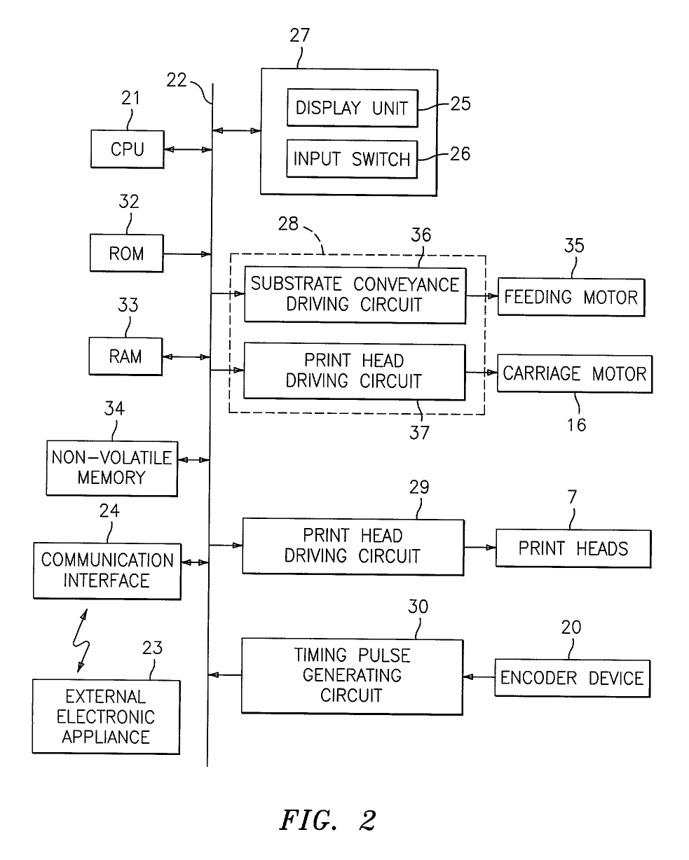

FIG. 2 shows a block diagram of a control system for the printing mechanism, 1. Referring to FIG. 2, a CPU, 21, is connected via buses, 22, such as a data bus, an address bus, and the like, to various components, for example, a communication interface, 24, for the exchange of various data with an external electronic appliance, 23; an operating panel, 27, having an input switch, 26, and a display unit, 25, formed by a liquid crystal display, LED display lamps or the like; a motor driving circuit, 28, for driving the print head drive mechanism, 6, and the substrate conveying motor (not shown), said motor driving circuit, 28, including a substrate conveyance driving circuit, 36, for driving the substrate conveying motor (not shown) and a print head driving circuit, 37, for driving the carriage motor, 14; a print head driving circuit, 29, for driving the print head(s) and the piezoelectric elements contained therein; a timing pulse generating circuit, 30, for generating various timings based on signals from the encoder device, 20; a ROM, 32, a RAM, 33; a non-volatile memory (for example, EEPROM) 34; and the like.

The ROM, 32, stores a reception control program for receiving image data, control data, and the like, from the external electronic appliance, 23, a control program for driving and controlling the motor driving circuit, 28, the print head driving circuit, 29, and the like, and a program for controlling the display or input in the operating panel, 27, and the like. The RAM, 33, has various storage areas, such as a buffer for storing image data, control data, and the like, received from the external electronic appliance, 23, various memories and buffers for print control, and the like. The non-volatile memory, 34, stores various values that need to be retained even after the printing mechanism is powered off.

Thus, in accordance with this invention, a substrate will be conveyed through a printing mechanism, such as that described in FIGS. 1 and 2. The printing mechanism will selectively apply the activator composition to the substrate in the positive image of the pattern desired to be plated. In the case of printed circuit fabrication, the substrate will be a flexible or rigid insulating substrate and the printing mechanism will apply the activator composition selectively to portions of the substrate in the positive image of the circuit features to be coated by plating.

Once the activator composition is selectively applied to the substrate in the positive image of the desired pattern, typically, the activator composition, applied to the surface of the substrate, is allowed to dry in place. The entire substrate is then contacted with a plating bath, usually by immersion of the substrate therein, such that the plating bath deposits metal onto the portions of the substrate that have had activator composition applied to them. An electroless plating bath, typically copper or nickel electroless plating baths, are useful in this regard. The electroless plating bath must be catalytically prompted to plate upon portions of the substrate which have activator composition applied to them but must substantially not plate upon areas of the substrate where no activator composition has been applied. Such electroless plating baths are well known in the art and include electroless copper plating baths comprised of copper sulfate (or chloride), sodium hydroxide, and formaldehyde and electroless nickel plating baths comprised of nickel sulfate, ammonium hydroxide and sodium hypophosphite. The substrate is left in contact with the plating bath for a time sufficient to plate the desired thickness of metal onto the portions of the substrate which have activator composition applied to them. Various additives known in the art can be added to the electroless plating bath to vary the speed of the plate, adjust the physical properties of the plated metal, and/or to minimize the degree of extraneous plating (i.e., plating upon areas without activator composition). With regard to electroless plating baths, reference is made to U.S. Pat. No. 4,209,331, the teachings of which are incorporated herein by reference in their entirety.

The invention herein is further described in the following example which should be taken as illustrative but not limiting.

### EXAMPLE I

A circuit pattern design was developed using a computer aided design program. The circuit pattern design was then electronically transferred from a personal computer to a Color Span® printer (available from Color Span Corporation of Eden Prairie, Minn.) through which a rigid insulting epoxy-glass FR-4 laminate was conveyed. The print head of the Color Span® printer had previously been charged with MacTivate 10®, a colloidal palladium activator composition available from MacDermid, Incorporated of 245 Freight Street, Waterbury, Conn. 06702. As the FR-4 laminate was conveyed through the Color Span® printer, the print head moved orthogonally to the direction of conveyance of the FR-4 laminate and while doing so selectively applied the MacTivate 10® activator composition to portions of the surface of the FR-4 laminate in the positive image of the circuit pattern design.

After processing the FR-4 laminate through the Color Span® printer, the MacTivate 10® activator composition is allowed to dry in place on the surfaces of the FR-4 laminate. The FR-4 laminate is then immersed in MacDermid MacuDep 70 electroless copper plating solution (available from MacDermid, Incorporated, 245 Freight Street, Waterbury, Conn. 06702) for 3 hours at 120° F. The FR-4 laminate was then removed, rinsed and dried. Copper had plated upon the FR-4 laminate in the positive image of the circuit pattern design.

What is claimed is:

1. A process for selectively depositing metal upon a first portion of a substrate, said process comprising:
a. using a print head to apply an activator composition to a surface of the substrate in the positive image of a predetermined pattern;
b. contacting the substrate with a plating bath;
wherein plating occurs upon the first portion of the substrate where the activator composition has been applied but substantially no plating occurs upon a second portion of the substrate where no activator composition has been applied.

2. A process according to claim 1, wherein the activator composition is selected from the group consisting of a colloidal dispersions of a noble metal and ionic solutions of a noble metal.

3. A process according to claim 1, wherein the substrate is conveyed through a printing mechanism comprising the print head, and the print head moves substantially orthogonally to the direction of conveyance of the substrate, wherein the print head comprises a reservoir for the activator composition, at least one nozzle, and a spray control means which is capable of initiating and terminating the ejection of activator composition in the direction of the substrate.

4. A process according to claim 1, wherein the print head moves across the substrate in the positive image of the predetermined pattern and applies an activator composition in said predetermined pattern.

5. A process according to claim 3, wherein the spray control means comprises a piezoelectric element.

6. A process according to claim 4, wherein the activator composition is selected from the group consisting of colloidal dispersions of a noble metal and ionic solutions of a noble metal.

7. A process according to claim 5, wherein the activator composition is selected from the group consisting of colloidal dispersions of a noble metal and ionic solutions of a noble metal.

8. A process according to claim 6, wherein the noble metal is selected from the group consisting of gold, palladium, and mixtures thereof.

9. A process according to claim 7, wherein the noble metal is selected from the group consisting of gold, palladium and mixtures thereof.

10. A process for selectively depositing metal upon a first portion of a substrate, said process comprising:
a. using a printing mechanism comprising, a print head comprising a spray control means, and a registration means, wherein the print head applies an activator composition to a surface of the substrate in the positive image of a predetermined pattern;
b. contacting the substrate with a plating bath;
wherein the registration means controls movement of the print head in relation to the substrate, and the spray control means starts and terminates a flow of activator composition from the print head to the substrate, each in accordance with signals received from a central processing unit; and
wherein plating occurs upon the first portion of the substrate where the activator composition has been applied but substantially no plating occurs upon a second portion of the substrate where no activator composition has been applied.

11. A process according to claim 10, wherein the substrate is conveyed through the printing mechanism while the print head moves substantially orthogonally to the direction of conveyance of the substrate.

12. A process according to claim 10, wherein the print head also comprises a reservoir for the activator composition and at least one nozzle through which activator composition flows toward the substrate.

13. A process according to claim 10, wherein the spray control means comprises a piezoelectric element.

14. A process according to claim 11, wherein the spray control means comprises a piezoelectric element.

15. A process according to claim 12 wherein the spray control means comprises a piezoelectric element.

16. A process according to claim 15, wherein the activator composition is selected from the group consisting of colloidal dispersions of a noble metal and ionic solutions of a noble metal.

17. A process according to claim 16, wherein, the noble metal is selected from the group consisting of gold, palladium and mixtures thereof.
